(19) United States
(12) Patent Application Publication
(10) Pub. No.: US 2006/0164209 A1
(43) Pub. Date: Jul. 27, 2006

(54) Entry system

(75) Inventor: Stephan De Zeeuw, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/521,702

(22) PCT Filed: Jul. 11, 2003
(86) PCT No.: PCT/IB03/03124

§ 371 Date: Jan. 19, 2005

(30) Foreign Application Priority Data
Jul. 20, 2002 (DE) 102 33 122.7

(51) Int. Cl. G05B 19/00

(52) U.S. Cl. 340/5.72; 340/5.61

(57) ABSTRACT

The invention relates to an entry system which includes a base station (1) and at least one auxiliary station (2), the base station (1) transmitting a request bit sequence which is modulated on an RF carrier and comprises n data words of at least one bit each to the auxiliary station (2) in order to grant entry to the auxiliary station (2), which auxiliary station retransmits a response bit sequence which is modulated on an RF carrier and comprises m data words of at least one bit each to the base station (1), the base station (1) comparing the response time between the transmission of at least a few data words of the request bit sequence and the reception of the respective associated data words of the response bit sequence with a permissible response time, the auxiliary station (2) being granted entry only if the permissible response time for the tested data words of a response has been exceeded a number of times which is smaller than the value imposed by a maximum error count.

The invention relates to an entry system which includes a base station and at least one auxiliary station, the base station transmitting a request bit sequence which is modulated on an RF carrier and comprises data words of at least one bit each to the auxiliary station in order to grant entry to the auxiliary station, which auxiliary station retransmits a response bit sequence which is modulated on an RF carrier and comprises data words of at least one bit each to the base station.

An entry system of this kind is a so-called passive keyless entry system which offers a significantly improved protection against external attacks in comparison with other systems. Systems of this kind are also used to an increasing extent in the field of vehicle entry systems. However, they are also suitable for the implementation of entry systems in buildings or the like.

A potential security problem faced by such systems is that a non-authorized attacker could perform a so-called relay attack. Using two so-called relay stations, an additional bi-directional connection is then built up in the radio link between the base, station and the auxiliary station. The actually authorized auxiliary station may then be present in a more remote location, for example, at the area of the actually authorized user of the auxiliary station. The attacker utilizes the relay link to obtain an authorization for entry from the base station by way of the actually authorized auxiliary station which, however, is situated in a different location.

For the recognition of such a relay attack it is known (from PCT application WO 0012848) to perform an oscillation count on the RF carrier wave, on which bit sequences are modulated, in the period between the transmission and the reception in order to determine the delay time between the request bit sequence and the response bit sequence retransmitted by the auxiliary station. From this publication it is also known to perform a phase comparison and/or a frequency comparison between the transmitted carrier wave and the received carrier wave. Indirect delay time measurement is thus performed by means of given signal characteristics. The essential drawback of this arrangement consists in the comparatively large expenditure to be made; this is notably undesirable, for example, in the construction of vehicles.

It is an object of the invention to provide an entry system of the kind set forth which is resistant against so-called relay attacks and nevertheless requires an as small as possible expenditure.

This object is achieved in accordance with the invention by means of an entry system as disclosed in the characterizing part of claim 1, which entry system includes a base station and at least one auxiliary station, the base station transmitting a request bit sequence which is modulated on an RF carrier and comprises n data words of at least one bit each to the auxiliary station in order to grant entry to the auxiliary station, which auxiliary station retransmits a response bit sequence which is modulated on an RF carrier and comprises m data words of at least one bit each to the base station, the base station comparing the response time between the transmission of at least a few data words of the request bit sequence and the reception of the respective associated data words of the response bit sequence with a permissible response time, the auxiliary station being granted entry only if the permissible response time for the tested data words has been exceeded a number of times which is smaller than the value imposed by a maximum error count.

In the entry system in accordance with the invention the request bit sequence comprises data words which comprise at least one bit each. The response bit sequence retransmitted by the auxiliary station comprises m data words which also comprise at least one bit each. The request bit sequence contains at least a few data words whereto a response is to be provided by the base station by way of respective associated data words of the response bit sequence. In other words, the request bit sequence may include data words in response to which no data words are retransmitted by the auxiliary stations. However, there are also data words for which a response is expected in the form of a corresponding data word of the response bit sequence. Thus, for such data words for which a response is expected a respective, corresponding, associated data word is included in the response bit sequence.

The invention is based on the idea to compare the response time between the transmission of such a word of the request bit sequence, for which an associated response data word is expected, and the arrival of this response data word with a maximum permissible response time.

Because a request bit sequence contains a plurality of data words for which the response data words of the response bit sequence are expected, such a comparison with the maximum selected response time is performed for each of these associated data words. Thus, the comparison with the maximum response time takes place within a request bit sequence for all data words for which associated data words exist in the retransmitted response bit sequence.

The invention offers a number of advantages in comparison with the state of the art. On the one hand, as has already been stated, the response time can be tested a number of times within a request bit sequence, that is, exactly as often as there are associated data words between the request bit sequence and the response bit sequence. Thus, unlike in the state of the art, the response time is not tested just once within a response bit sequence.

Furthermore, in the entry system in accordance with the invention it is not necessary to measure the delay time by counting carrier waves or the like; instead it suffices to perform a simple delay time comparison between the response time and the maximum selected response time, which comparison can be comparatively simply implemented by means of delay members. It is not necessary to perform any counting operations, frequency measurements or phase comparisons.

Because the response time is tested several times within a request bit sequence in the described manner, the decision whether the response time is larger or smaller than the maximum permissible response time can be taken for each pair of the associated data words. Within a request bit sequence, therefore, a decision is taken a number of times. Consequently, a decision is also taken as to how often the maximum permissible response time was exceeded during a request bit sequence. If Such exceeding occurs a number of times which is larger than a preset maximum error count, an error or an attack is recognized and no entry is granted. However, entry is granted in the other case.

In conformity with an embodiment of the invention as disclosed in claim 2, after the transmission of a data word of the request bit sequence first the reception of the associated data word of the response bit sequence is awaited and the described comparison with the maximum response time is performed. The next data word of the request bit sequence is transmitted only after that. In conformity with this procedure, for example, a decision as regards a permissible request can be interrupted already if the exceeding of the maximum number of errors is detected after several of such individual comparisons.

In conformity with a further embodiment of the invention as disclosed in claim 3, the request bit sequence may be, for example, a part of a so-called challenge response entry method. Methods of this kind are known from the state of the art, but can be advantageously used in the entry system in accordance with the invention, because during such a challenge response method a test already as regards a relay attack can already be performed at the same time, since multiple transmission and response is already incorporated in such entry methods.

The described maximum response time with which the measured times are compared can advantageously be conceived so as to be variable in conformity with a further embodiment of the invention as disclosed in claim 5. For example, it can be adaptable to response times which actually occur. This adaptation, of course, may not take place within a request procedure, because an undesirable adaptation to a relay attack would thus take place. However, it can be performed in a long-term fashion over a plurality of entry procedures, thus enabling, for example, adaptation to gradual changes of components.

In conformity with claim 4, each request bit sequence may comprise data words for which no associated data word exists in the response bit sequence, that is, data words whereto no direct response by way of a data word is envisaged. In conformity with claim 6, a retransmission of a data word in the response bit sequence may be made dependent on the contents of a data word of the request bit sequence. The contents can then be checked, but in conformity with claim 7 it is also possible to perform a retransmission of such an associated data word in dependence on a given bit sequence or a logic bit value within the data word of the request bit sequence. Alternatively, in conformity with claim 8 a decision can be taken on the basis of other data present in the base station.

An embodiment of the invention will be described in detail hereinafter with reference to the drawing. Therein:

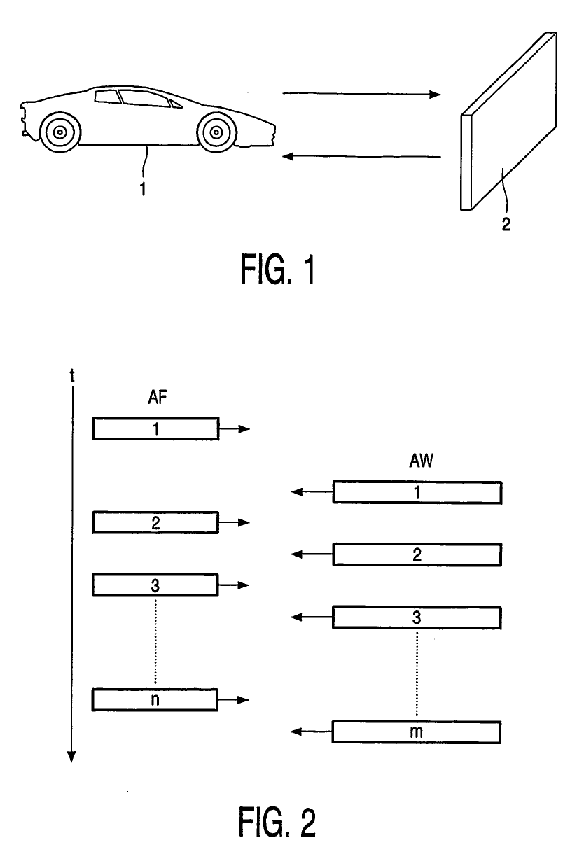

FIG. 1 is a diagrammatic representation of a base station in a vehicle and an auxiliary station in a chip card,

FIG. 2 is a diagrammatic representation of a request bit sequence and a response bit sequence, and

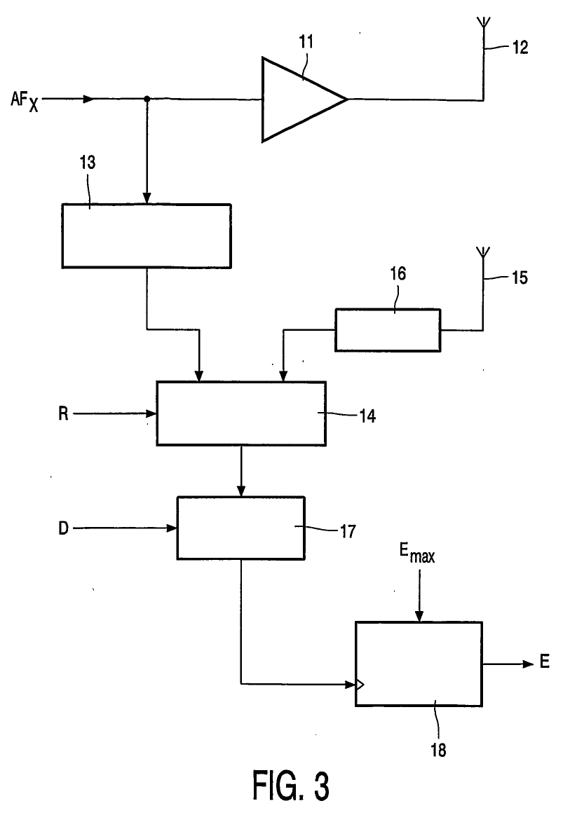

FIG. 3 shows a block diagram of a base station.

For the embodiment illustrated in the drawing it should be assumed that the entry system in accordance with the invention is intended for a vehicle; this means that the base station 1 is installed in a vehicle as shown in FIG. 1. There is provided at least one auxiliary station via which entry to the vehicle can take place, if desired. FIG. 1 shows an auxiliary station 2 which may be, for example, a chip card. Two arrows in FIG. 1 indicate diagrammatically that an exchange of data takes place between the base station 1 and the auxiliary station 2 via an RF link.

In conformity with the entry system in accordance with the invention a request bit sequence, which comprises data words of at least one bit each, is modulated on an RF carrier and transmitted to the auxiliary station 2. This can take place, for example, whenever it is signaled to the base station 1, by activation of the door handle of the vehicle, that permission for entry is requested. The base station 1 then transmits such a request bit sequence whereto the auxiliary station 2 responds by way of a response bit sequence which is transmitted to the base station 1 and comprises data words of at least one bit each.

For example, use can be made of a so-called challenge response method in which the base station transmits the so-called challenge in the request bit sequence, which challenge is converted into a response in the auxiliary station 2 by means of a cryptographic algorithm and a secret key. This response is then retransmitted to the base station 1 in the form of the response bit sequence and the base station compares the response with the reference response by means of an identical cryptographic algorithm and the same secret key. In the case of correspondence, in principle a permission for entry is issued, provided that the permissible response time has not been exceed a number of times which is larger than a predetermined maximum error count as will be described hereinafter.

When a permission for entry is granted in the situation shown in FIG. 1, the auxiliary station 2, for example, in the chip card, is present in the vicinity of the vehicle. The authorized user carries said chip card and can activate, as explained above, the base station 1 by activating a sensor on the vehicle, so that the described procedure for granting entry can take place. However, it may occur that a so-called relay attack is carried out which is not recognized by evaluation of the contents of the data words. In that case no direct connection via an RF carrier occurs between the base station 1 and the sub-station 2, as shown in FIG. 1, but a so-called relay link is connected between these two stations. The data words are then transmitted, possibly over a large distance, via such a relay link. In that case the auxiliary station 2 is situated far from the vehicle 1 and hence from the base station 1, so that direct transmission no longer takes place between these stations. However, such transmission can take place via the relay link so that an undesirable grant of entry is issued. This is because a request bit sequence can be triggered at all times by unauthorized users via this relay attack, which request bit sequence is transmitted to a remote auxiliary station 2 via the relay link. Thus, when such a relay link is used, any person having established such a link and having performed the procedure for obtaining entry to the vehicle can be granted entry to the vehicle. During the transmission to and fro of the data words via such a relay link, however, delay times occur which are longer than those occurring during the direct transmission of the data between the base station 1 and the auxiliary station 2. Direct measurement of the delay times would enable recognition of such a relay attack, but would also necessitate a comparatively large expenditure on components at least in the base station 1.

In the entry system in accordance with the invention, therefore, a comparison is carried out between the response times actually occurring and a maximum permissible response time as will be described hereinafter. Because such a comparison can be performed by means of a simple delay member and a comparator, the expenditure on necessary components is much smaller. Furthermore, a respective comparison with the maximum response time can be performed for a plurality of data words and correspondingly associated, transmitted data words, so that a multiple comparison with the maximum permissible response time can be carried out within a request bit sequence and a retransmitted response bit sequence instead of only one comparison for the entire bit sequence.

FIG. 2 is a diagrammatic representation of the described procedure involving the transmission of the data words of a request bit sequence AF and the retransmission of data words of a response bit sequence AW.

In conformity with the diagrammatic representation in FIG. 2, the timing in the embodiment of the invention is such that the base station 1 first transmits a data word 1 of the request bit sequence to the auxiliary station 2 which retransmits a data word 1 of the response bit sequence AW to the base station 1 in response thereto. This procedure is repeated with further data words until finally the base station 1 has transmitted the last data word n of the request bit sequence and the sub-station 2 has responded by way of the data word m of the response bit sequence. The number of data words of the request bit sequence and the number of data words m of the response bit sequence need not be the same. This is because it is possible for the request bit sequence to contain data words for which no associated data words exist in the response bit sequence, that is, data words whereto there is no response in the form of a data word in the response bit sequence. The foregoing can be made dependent (in a manner not shown in the drawing) on the contents of a data word of the request bit sequence AF. For the representation in FIG. 2, however, it has been assumed for the sake of simplicity that an associated data word of the response bit sequence AW exists for each data word of the request bit sequence AF.

FIG. 2 shows that after transmission of a data word of the request bit sequence AF, first the reception of the associated data word of the response bit sequence AW is awaited. The base station 1 transmits the next data word of the request bit sequence AF only after the reception of said associated data word of the response bit sequence.

This approach makes sense in the case of a challenge response method, but for other methods interleaving can also be used for the data words.

FIG. 3 shows a block diagram of a part of the entry system as it is provided in the base station 1.

As has already been explained, the base station 1 generates data words within a request bit sequence. FIG. 3 shows that these data words AFₓ are applied to a transmission antenna 12 by way of an output amplifier L. The data words AFₓ are modulated, in a manner not shown in FIG. 3, on an RF carrier by means of a modulator. In this modulated form they are transmitted as RF pulses from the transmission antenna 12 to the auxiliary station 2.

The base station is provided with a delay member 13 as shown in FIG. 3, which delay member, for example, delays a transmitted data word AF by a given delay time which concerns a maximum permissible response time. The correspondingly delayed output signal of the delay member 13 reaches a decider 14.

The decider 14 is also supplied with a data word from the auxiliary station 2 (not indicated in FIG. 3), which data word is modulated on an RF carrier and received by means of a receiving antenna 15. This data word is detected by means of a detector 16 and is also applied to the decider 14.

The delay member 13 may then be implemented in a comparatively simple way, for example, as a surface acoustic wave element or as a serial arrangement of logic gates.

The decider circuit 14 may be realized, for example, as a simple bistable flipflop, the value of the output signal of which no longer changes once a decision has been taken. This simple decision is taken on the basis of the fact which of the two signals from the delay member 13 and from the detector 16 reaches the decider 14 first. Depending on this outcome, the output of the decider 14 outputs a logic 1 if the pulse delivered by the delay member 13 reaches the decider first. This is the case, for example, when the auxiliary station 2 does not retransmit a pulse or when this pulse exceeds the maximum permissible delay time.

Conversely, the output of the decider outputs a logic 0 when the pulse retransmitted by the auxiliary station 2, that is, the retransmitted data word of the data word bit sequence, reaches the decider 14 before the pulse delivered by the delay member 13.

The decider 14 is reset by means of a signal R prior to each new decision process.

This output signal of the decider 14 is evaluated by means of a logic circuit 17 which, for example, can take into account the fact whether any response of an associated data word of the response bit sequence was awaited in response to a transmitted data word. To this end it is supplied with a signal D which forms the basis for this decision.

In all cases in which an actual evaluation of the output signal of the decider 14 is to be performed, the logic circuit 17 applies this signal to a counter 18 which counts for a plurality of data words transmitted within a request bit sequence the corresponding comparison results delivered by the decider 14.

In the present example the decider 14 supplies a 1 whenever the response of an associated data word is too late or does not occur at all. This is evaluated by the logic circuit 17 and applied to the counter 18 which counts the logic ones for all data words within a request bit sequence.

Using the counter 18, furthermore, a comparison can be performed between the actually occurring errors, counted by the counter 18 during the reception/transmission of a request bit sequence and a response bit sequence, and a maximum permissible error count Eₘₐₓ. This operation can be performed, for example, by setting the counter 18 to this maximum error count Eₘₐₓ prior to the transmission of a request bit sequence and by decrementing this counter in response to each actually occurring error 1, applied to the counter 18 by the decider 14 of the logic circuit 17, until the value 0 is reached in the counter 18. If this value is reached within a request bit sequence and a retransmitted response bit sequence, the maximum error count Eₘₐₓ has been reached and no permission for entry is granted for this request bit sequence.

However, if the maximum error count Eₘₐₓ has not been reached at the end of the transmission and retransmission of data words of a request bit sequence and associated data words of a response bit sequence, a permission for entry can be transmitted to the relevant auxiliary stations.

In the representation of the block diagram of FIG. 3 this decision can be taken simply on the basis of the output signal E of the counter 18 at the end of such a request operation.

The representation of the block diagram of FIG. 3 shows that the entry system in accordance with the invention does not involve direct measurement of response times. It is not necessary either to detect phases or frequency relationships of the transmitted and received RF carrier. Instead, for each data word a simple comparison of the actual response time with a maximum predetermined response time is carried out by means of the delay member 13 and the decider 14. The maximum permissible response time is then given by the delay time delivered by the delay member 13.

If desired, the response time delivered by the delay member 13 may also be made variable so as to enable adaptation to various conditions. Overall, the entry system in accordance with the invention enables comparatively reliable recognition of a relay attack, because a comparison of the actual response time with a maximum permissible response time can be carried out for a plurality of data words of the request bit sequence and respective associated data words of the response bit sequence. A multiple comparison can thus be performed within such a bit sequence.

1. An entry system which includes a base station (1) and at least one auxiliary station (2), the base station (1) transmitting a request bit sequence which is modulated on an RF carrier and comprises n data words of at least one bit each to the auxiliary station (2) in order to grant entry to the auxiliary station (2), which auxiliary station retransmits a response bit sequence which is modulated on an RF carrier and comprises m data words of at least one bit each to the base station (1), the base station (1) comparing the response time between the transmission of at least a few data words of the request bit sequence and the reception of the respective associated data words of the response bit sequence with a permissible response time, the auxiliary station (2) being granted entry only if the permissible response time for the tested data words of a response has been exceeded a number of times which is smaller than the value imposed by a maximum error count.

2. An entry system as claimed in claim 1, characterized in that the base station (1) determines the response time of the respective associated data word of the response bit sequence each time after the transmission of a data word of the request bit sequence, compares it with the maximum permissible response time, and transmits the next data word of the request bit sequence only after that.

3. An entry system as claimed in claim 1, characterized in that the request bit sequence and the response bit sequence form part of a challenge response entry system.

4. An entry system as claimed in claim 1, characterized in that the base station (1) expects a respective associated data word of the response bit sequence only in response to a few predetermined data words of the request bit sequence.

5. An entry system as claimed in claim 1, characterized in that the maximum response time is variable, that is, notably adaptable to actually occurring response times.

6. An entry system as claimed in claim 1, characterized in that the retransmission of a data word in the response bit sequence is dependent on the contents of the associated data word of the request bit sequence.

7. An entry system as claimed in claim 6, characterized in that the retransmission of a data word of the response bit sequence in response to an associated data word of the request bit sequence takes place only if the data word of the response bit sequence has a predetermined logic bit value.

8. An entry system as claimed in claim 6, characterized in that the retransmission of a data word of the response bit sequence in response to an associated data word of the request bit sequence takes place in dependence on data present in the base station.

9. The use of an entry system as claimed in one of the claims 1 to 8 in a vehicle.
